(19) United States
(12) Patent Application Publication
(10) Pub. No.: US 2020/0337244 A1
(43) Pub. Date: Oct. 29, 2020

(54) Cutting Device for Agricultural Crop

(71) Applicant: Maschinenfabrik Bernard Krone GmbH & Co. KG, Spelle (DE)

(72) Inventors: Felix Kalverkamp, Recklinghausen (DE); Justus Trentmann, Glandorf (DE)

(21) Appl. No.: 16/861,341

(22) Filed: Apr. 29, 2020

(30) Foreign Application Priority Data
Apr. 29, 2019 (DE) 10 2019 003 035.4

(51) Int. Cl. A01D 90/04; A01F 15/10

(52) U.S. Cl. CPC A01D 90/04; A01F 15/10

(57) ABSTRACT

A cutting device for agricultural crop has cutting elements and a rotor element rotating in operation about a rotor axis. The cutting elements are arranged in a cutting position stationarily relative to the rotor element and are able to yield in a springy fashion. The rotor element has a central body that is provided with a central conveying section and with at least one axial conveying section. The central conveying section has central conveying elements correlated with the cutting elements. The at least one axial conveying section is provided with an axial conveying element extending spirally at least in sections about the rotor axis. The at least one axial conveying section of the central body has a first radius and the central conveying section of the central body has a second radius, wherein the first radius is larger than the second radius.

### BACKGROUND OF THE INVENTION

The invention relates to a cutting device for agricultural crop. The cutting device comprises a plurality of cutting elements and a rotor element that rotates about a rotor axis in operation. The cutting elements are provided so as to yield in a springy fashion relative to the rotor axis in a cutting position. The rotor element comprises a central body on which, in a central conveying section of the rotor element, a plurality of central conveying elements are arranged which are correlated with a cutting element, respectively. At the central body, in at least one axial conveying section of the rotor element, at least one axial conveying element is arranged that extends at least in sections in a spiral shape about the axis of rotation.

EP 0 815 720 B1 discloses a cutting device of the aforementioned kind. In operation, the crop is conveyed by the central conveying elements along the cutting elements in the cutting position and cut by the cutting elements. Due to the axial conveying element, the crop can be conveyed in axial direction to the central conveying section.

A disadvantage of the cutting device of the aforementioned kind is that a large portion of the crop is conveyed by the axial conveying element laterally against the nearest cutting element causing an increased component load and a deficient cutting of the crop.

Object of the invention is to increase the reliability of the cutting devices of the aforementioned kind as well as the quality of the crop that is cut therewith.

### SUMMARY OF THE INVENTION

In accordance with the invention, this object is achieved in that a radius of the central body in the axial conveying section is at least in sections thereof larger than a radius of the central body in the central conveying section.

The cutting device according to the invention is configured in particular for use in agricultural machines. The cutting device forms in particular at least partially a conveying channel, and the central conveying section adjoins preferably this conveying channel. The cutting elements are preferably arranged at least in the cutting position below the rotor axis so that the crop is moved by undershot conveyance by the rotor element in operation. The cutting elements project in their cutting position into the conveying channel in particular from a wall of the conveying channel that is positioned opposite to the rotor element. In operation of the cutting device, the cutting elements are preferably supported so as to yield in the cutting position in order to be able to give way to foreign bodies in the conveying channel. The cutting elements are in particular supported so as not to rotate about the rotor axis. When the cutting device is not operating, groups of cutting elements can be preferably selected which are in the cutting position in the following operation.

The central conveying section has an extension in the direction of the rotor axis which in particular corresponds to the width of the conveying channel, preferably corresponds to the width of a pressing chamber which is downstream of the conveying channel. In particular, the central conveying section has a width of at least substantially 1.2 m. In combination, the central conveying section and the at least one axial conveying section have in particular a width of at least substantially 2 m or more.

The axial conveying section of the rotor element adjoins in axial direction the central conveying section. In particular, the rotor element has two axial conveying sections which, viewed in the overall conveying direction, preferably from the front, are arranged to the left and to the right of the central conveying section. The at least one axial conveying section serves for feeding crop, which has reached the rotor element adjacent to the central conveying section, toward the central conveying section. By means of the axial conveying element that is spirally shaped at least in sections, the crop which is present in this region is subjected in operation to an axial conveying impulse.

The rotor element is particularly embodied for a rotation at 110 rpm to 180 rpm (revolutions per minute). The central body which is extending preferably across the entire length or width of the rotor element is in particular embodied as a shaft, preferably as a hollow shaft, with an outer surface which is closed in axial direction as well as in circumferential direction. On this surface, the central conveying elements are attached in the central conveying section and the at least one axial conveying element is attached in the at least one axial conveying section. Between two central conveying elements, the conveying channel adjoins in particular also the central body or its surface. The at least one axial conveying element also does not cover, in particular areally, the central body in the axial conveying section but adjoins only a small portion of its surface. The conveying elements are in particular secured rigidly to the central body, preferably are welded thereto. In case of a multi-part configuration of the central body, for example, when comprised of partial shaft pieces of different radii, these partial shaft pieces are also preferably rigidly connected to each other, particular preferred welded to each other.

Each cutting element has preferably correlated therewith at least one central conveying element. In particular, each cutting element has correlated therewith at least one pair of central conveying elements which form a gap extending in radial direction between them and, in operation, rotate along the respective cutting element on both sides. Preferably, each cutting element has correlated therewith a plurality of such pairs, preferably three pairs, which are distributed about the circumference of the rotor element. By a meshing movement of the central conveying elements with the cutting elements, an effective cutting of the crop is realized.

Since the central body has a larger radius in the axial conveying section than in the central conveying section, in the axial conveying section an intermediate space between the surface of the central body and an imaginary cylinder-shaped envelope of the rotor element is reduced, wherein the radius of the envelope in particular corresponds to the outer radius of the rotor element. At the same time, due to a reduced radius of the central body in the central conveying section, a large conveying channel cross section and therefore a high cutting output is enabled. The larger radius of the central body in the axial conveying section ensures especially that the amount of crop that can get caught in the intermediate space in the axial conveying section is reduced and that a load that can be exerted laterally by the crop after its axial conveying on the in particular outer cutting element is reduced. By increasing the inner diameter of this space, in particular a critical load of the section of the cutting element that is nearest the central body in the central conveying section is reduced, wherein this section in particular projects farthest into the conveying channel and therefore is relatively fragile. The larger central body radius ensures an axial conveyance of the crop in a region, viewed parallel to the rotor axis, in front of the cutting elements and prior to the crop reaching a part of the intermediate space which is located immediately adjacent to the cutting element. The larger radius of the central body in the axial conveying section prevents substantially that the crop in the axial conveying section penetrates the envelope. As a whole, the solution according to the invention enables the axial conveyance and cutting of a greater crop quantity while energy consumption is reduced and effects a longer service life of the individual components due to the reduced component load.

In particular, the central conveying elements have the same outer radius as the at least one axial conveying element. A wall of the cutting device, which is stationary relative to the rotor axis and in particular delimits at least partially the conveying channel, extends at least partially across the entire width of the rotor element parallel to the rotor axis. Due to this configuration, the crop upon axial conveyance from the axial conveying section to the central conveying section must not overcome a step so that the conveying performance is further improved.

Preferably, the ratio between the radius of the central body in the axial conveying section and the radius of the central body in the central conveying section is at least 1.1, preferably at least 1.4, particularly preferred at least 1.6, and/or at most 2.5, preferably at most 2.1, preferably at most 1.8. Due to this radii ratio, in addition to a conveying channel cross section which has been proven successful in practice, an axial conveying section is provided which substantially prevents filling of the intermediate space and, at the same time, exerts a best possible axial conveying action on the crop.

Preferably, the ratio between the radius of the outer diameter of the axial conveying element and the radius of the central body in the axial conveying section is at most 2.0, preferably at most 1.7, particularly preferred at most 1.5, and/or at least 1.2, preferably at least 1.3, particularly preferred at least 1.4. Due to this ratio, a particularly high conveying action can be obtained and the crop can be conveyed optimally in front of the nearest and in particular conventionally embodied cutting elements.

In an advantageous embodiment of the invention, the ratio between a difference that represents the deviation of an outer radius of the rotor element from the radius of the central body in the central conveying section and a difference that represents a deviation of the outer radius of the rotor element from the radius of the central body in the axial conveying section is at least 1.2, preferably at least 1.6, particularly preferred at least 1.9, and/or at most 4.0, preferably at most 3.0, particularly preferred at most 2.0. The outer radius of the rotor element in this context is preferably identical to the outer radius of the central conveying elements and/or the outer radius of the at least one axial conveying element. The differences represent each a gap width or extension of the intermediate space measured in radial direction. Due to the ratio, a conveying channel which is suitable for high cutting outputs and provided with conventionally employed reliable components can be used and also the afore described advantages in the axial conveying section can be reliably achieved.

Preferably, the radius of the central body in the axial conveying section amounts to at least 120 mm, preferably at least 160 mm, particularly preferred at least 180 mm and/or at most 250 mm, preferably at most 210 mm, particularly preferred at most 190 mm. Due to these preferred radii ranges, winding of crop about the central body in the axial conveying section is effectively avoided and, at the same time, a circumferential speed which is critical in practice at conventional rotary speeds that avoid the risk of a pulling action into the intermediate space in the axial conveying section.

In an advantageous embodiment of the invention, the difference between the outer radius of the rotor element and the radius of the central body in the axial conveying section is at least 40 mm, preferably at least 60 mm, particularly preferred at least 75 mm, and/or at most 120 mm, preferably at most 100 mm, particularly preferred at most 85 mm. Due to this height, measured in radial direction, of the space between the surface of the central body in the axial conveying section and the envelope of the axial conveying section, an optimal degree of crop penetrating into the intermediate space is achieved which is required for transmitting the axial conveying impulse.

The at least one axial conveying element is embodied in particular to extend circumferentially about the central body across the entire axial extension of the axial conveying section. In this context, the axial conveying element extends circumferentially about the central body in particular several times to less than one time. Alternatively, the thread pitch of the axial conveying element is so large that the axial conveying element extends circumferentially only about a portion of the central body. The thread pitch of the axial conveying element is in particular constant across its entire axial extension.

In the at least one axial conveying section, preferably a plurality of axial conveying elements, in particular three, that are interposed among each other are arranged at the central body. They form together a multiple-thread axial conveying device. The preferred three axial conveying elements have in particular ends facing the central conveying section that are displaced relative to each other by 120°. The thread spacing of the axial conveying elements relative to the neighboring ones in axial direction is preferably identical and in particular constant along their circumference. Due to the increase of the number of axial conveying elements, on the one hand, their pitch can be increased without having to increase the spacing of two threads neighboring each other in axial direction. On the other hand, this spacing can be reduced without having to reduce the pitch. As a whole, a higher axial conveying speed can be produced in this way and a higher mass flow of crop can be supplied to the central conveying section. Due to the higher axial conveying speed, the crop is in particular not only conveyed in front of the nearest cutting element but partially in front of further cutting elements which are spaced farther away from the axial conveying section so that the load on the cutting elements is more uniformly distributed.

In case of only one axial conveying element per axial conveying section, axial conveying element has an individual pitch of at least 100 mm, preferably at least 120 mm, particularly preferred at least 140 mm, and/or at most 200 mm, preferably at most 170 mm, in particular preferred at most 150 mm. The pitch or individual pitch is in this context the travel length in axial direction that is covered in the axial direction by the axial conveying element per complete revolution about the rotor axis. In case of only one axial conveying element, the pitch preferably matches the sum of the axial spacing of two neighboring axial conveying element sections plus the axial extension of one of them. In case of a plurality of interposed axial conveying elements, they have preferably a pitch which results from the product of their number and the aforementioned individual pitches. In this way, when increasing the number of axial conveying elements, their axial thread spacing is substantially maintained constant and the pitch is correspondingly increased. The thread spacing has been found to be advantageous for conventional agricultural crop. The larger pitch effects in operation a “faster” axial movement of the axial conveying elements which, in turn, leads to the aforementioned advantages. In this context, the different axial conveying elements are preferably equidistantly arranged relative to each other at the central body.

The at least one axial conveying element is in particular embodied as a coil-shaped sheet metal that projects upright away from the central body wherein the cross section of an axial conveying element section has an extension in radial direction that is a multiple of the extension in axial direction. The extension of the axial conveying element section in radial direction amounts to in particular 40 mm, preferably at least 60 mm and/or at most 120 mm, preferably at most 100 mm, and particularly preferred at most 80 mm. Due to this configuration, the at least one axial conveying element in operation forms at least one large conveying surface which is facing the central conveying section and by means of which the crop is axially moved.

In an advantageous embodiment of the invention, a spacing, measured in axial direction, between the at least one axial conveying element and the nearest cutting element amounts to at most 55 mm, preferably at most 45 mm, particularly preferred at most 35 mm. In this context, the axial conveying element projects in particular in axial direction into the intermediate space of the central conveying section and across the part of the central body with the largest radius. The spacing of the aforementioned cutting element relative to the central body in the axial conveying section in axial direction amounts to in particular at most 70 mm, preferably at most 60 mm, particularly preferred at most 50 mm. Due to this minimal spacing of the outer cutting element to the axial conveying section or to the axial conveying element, it is effectively avoided that uncut crop moves through without being cut between the cutting element and the axial conveying element in circumferential direction or in tangential direction. In addition, the axially conveyed crop can thus be effectively distributed onto several outer cutting elements.

Preferably, a reinforcement element is arranged at an end of the axial conveying element adjoining the central conveying section. The reinforcement element is in particular arranged at a side of the axial conveying element which is facing away from the central conveying section. In particular, the reinforcement element is of a wedge shape viewed in a section of the reinforcement element in which also the rotor axis is positioned. Preferably, the reinforcement element comprises at least one slanted support web extending from the central body all the way to a section of the axial conveying element that is spaced apart from the central body. The radius of this section deviates from the outer radius of the rotor element in particular less than it deviates from the radius of the central body in the axial conveying section. The reinforcement element extends preferably about a circumferential angle of <180° about the central body. Due to this embodiment, a greater stability of the at least one axial conveying element in the region adjoining the central conveying section is ensured and at the same time its conveying action is limited only minimally.

At the end of the axial conveying element which is facing away from the central conveying section, in particular a boundary element adjoins which extends in the circumferential direction about the rotor axis or has no thread pitch. The boundary element forms at least in sections a rim of the axial conveying section which in operation is circulating and improves the effect of the axial conveying element on the crop to be conveyed axially.

Preferably, the cutting device comprises at least one follower element which is arranged at the central body in the central conveying section and adjoins the axial conveying section. In particular, the follower element is also immediately attached to the axial conveying section. In particular, at the central conveying section a plurality, in particular three, follower elements are arranged for each axial conveying section. The at least one follower element has in particular an outer radius which substantially corresponds to the outer radius of the rotor element. Preferably, the follower element is designed as a tine which is extending mainly radially away from the central body. Advantageously, the follower element is not correlated with a cutting element and, therefore, at least one central conveying element is preferably located between the follower element and the nearest cutting element in axial direction, wherein the at least one central conveying element is correlated with the nearest cutting element. Due to the at least one follower element, the axial conveying action of the axial conveying element is enhanced also by the adjoining region of the central conveying section and, in this way, the proportion of uncut crop that passes the conveying channel laterally of an outer cutting element is further reduced.

Particularly preferred, the follower element is arranged in the region of an end of the axial conveying element which is facing the central conveying section. In particular, each one of the preferably three axial conveying elements of the axial conveying section has correlated therewith a follower element. Preferably, the follower element correlated with the axial conveying element is arranged so as to be leading or following the axial conveying element in operation by at most 10°. Due to this arrangement or combination of follower element and axial conveying element, the action of the axial conveying element on crop which is located in the boundary region between axial conveying section and central conveying section is significantly improved and the proportion of uncut crop is further reduced in this region.

In an advantageous embodiment of the invention, the cutting device has at least one guiding element that is arranged stationarily relative to the rotor axis. In the overall conveying direction, the guiding element is at least in sections thereof, in particular completely, arranged in front of the rotor axis, i.e., in case of use of the cutting device in a baler it is arranged in the travel direction behind the rotor axis. The guiding element has a guiding surface which is extending at least substantially transverse to the overall conveying direction, i.e., the guiding surface extends in particular parallel to the rotor axis and is in particular flat and/or substantially vertical. The axial extension of the guiding element corresponds substantially to the axial extension of the axial conveying section, i.e., amounts to at least 70%, preferably at least 80%, particularly preferred at least 90% thereof. Between the guiding element and the at least one axial conveying element, there remains in particular only a minimal gap; in the region of the gap, the crop to be axially conveyed is moved and, as needed, stripped off the axial conveying element.

When viewing the cutting device parallel to the rotor axis, the guiding element is preferably displaced relative to the rotor axis in a horizontal direction so far that the guiding surface is arranged in particular 0 mm to 200 mm, preferably 50 mm to 150 mm, particularly preferred 80 mm to 120 mm, in front of the rotor axis. Due to this configuration, crop which is conveyed to the axial conveying section first impinges on the guiding surface which brakes the movement of the crop in a radial or tangential direction. Arranged upstream of the guiding surface, the axial conveying element imparts an axial impulse onto the crop. In this way, an effective axial conveying of the crop is achieved and in particular a pulling action on the crop into the intermediate space is prevented.

The aforementioned object is further solved by an agricultural machine with the afore described cutting device. The agricultural machine is in particular designed as a baler or as a self-loading trailer.

### BRIEF DESCRIPTION OF THE DRAWING

FIG. 1 is an overview illustration of a cutting device according to the invention.

FIG. 2 is a front view of the cutting device according to FIG. 1.

FIG. 3 is an enlarged detail of the illustration according to FIG. 2.

FIG. 4 is a section view of the cutting device according to FIG. 1 transverse to the rotor axis.

FIG. 5 is an enlarged view of an axial conveying section of the cutting device according to FIG. 1.

FIG. 6 shows the axial conveying section according to FIG. 5 in a further illustration.

FIG. 7 shows a baler according to the invention.

The features of the embodiment according to the invention explained in the following can also be subject matter of the invention individually or in other combinations as those illustrated or described herein, but always in combination with the features of the independent claim.

If expedient, parts that are acting functionally in the same way are provided with identical reference characters.

### DESCRIPTION OF THE PREFERRED EMBODIMENTS

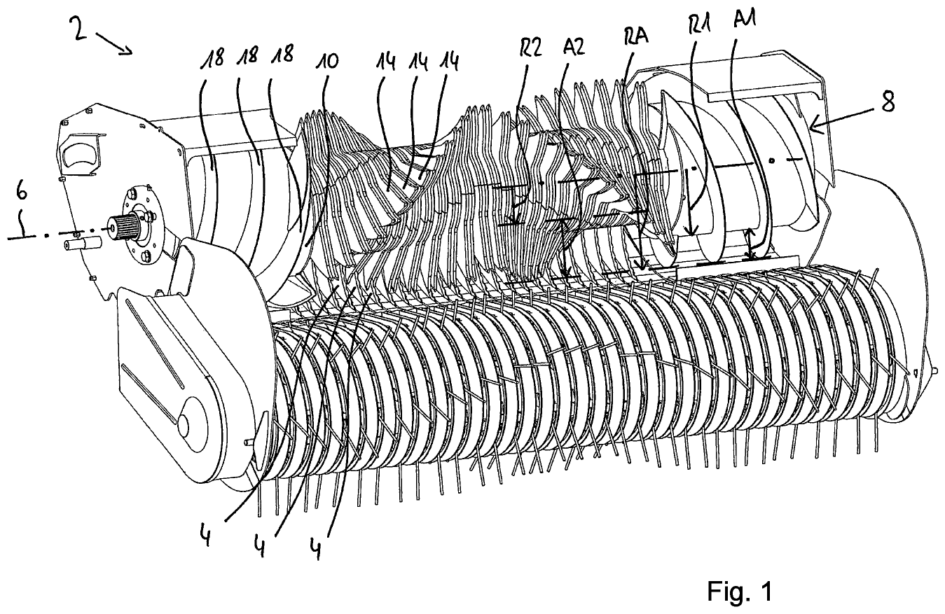

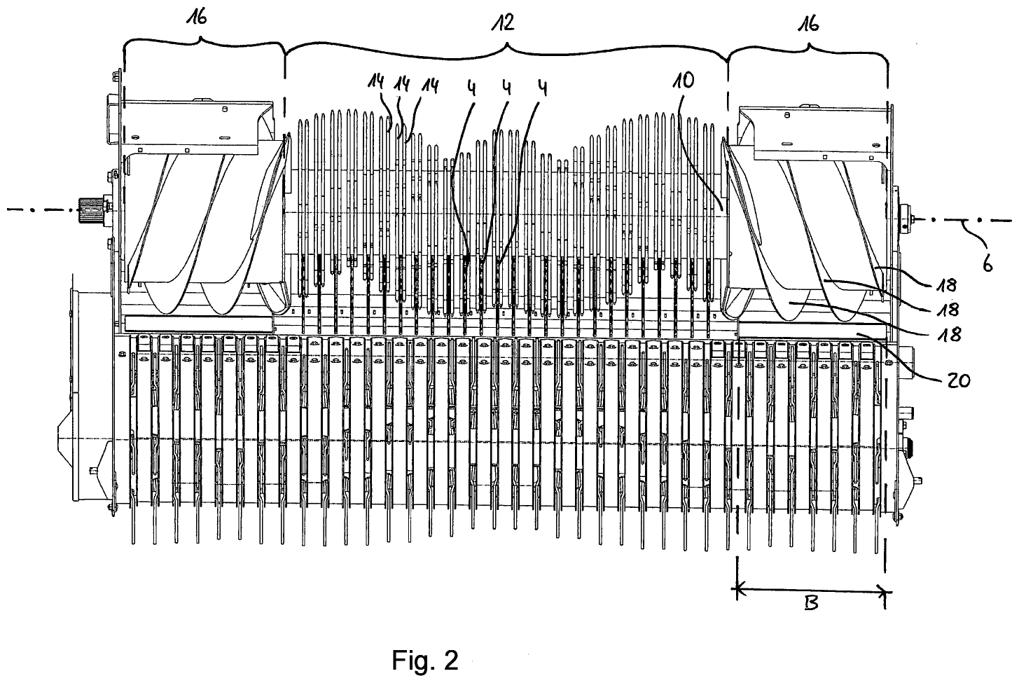

The cutting device 2 which is illustrated in FIGS. 1, 2, and 4 as a whole comprises twenty-six cutting elements 4; also, the cutting device 2 comprises a rotor element 8 which rotates about rotor axis 6 in operation. The cutting elements 4 are arranged in the illustrated cutting position so as to yield in a springy fashion relative to the rotor axis 6 and in particular are arranged so as not to circulate relative to the rotor axis 6.

The rotor element 8 has a central body 10 which is embodied as a hollow shaft. In a central conveying section 12, a plurality of central conveying elements 14 are arranged at the central body 10 of the rotor element 8. Six central conveying elements 14 are correlated with one cutting element 4, respectively, and are arranged in three pairs. The three pairs of central conveying elements 14 are distributed about the circumference of the rotor element 8. Each pair of central conveying elements 14 meshes in operation with the correlated cutting element 4. In this way, the crop is conveyed in tangential or circumferential direction in the central conveying section 12 and thereby cut.

In addition to the central conveying section 12, the rotor element 8 has at each end an axial conveying section 16. Both axial conveying sections 16 comprise three axial conveying elements 18 which are each embodied in sections thereof in a spiral shape extending about the rotor axis 6. By means of these axial conveying elements 18, crop that is supplied in particular by a pick-up toward the rotor element 8 is conveyed in an axial direction toward the central conveying section 12 across the entire width of the rotor element 8.

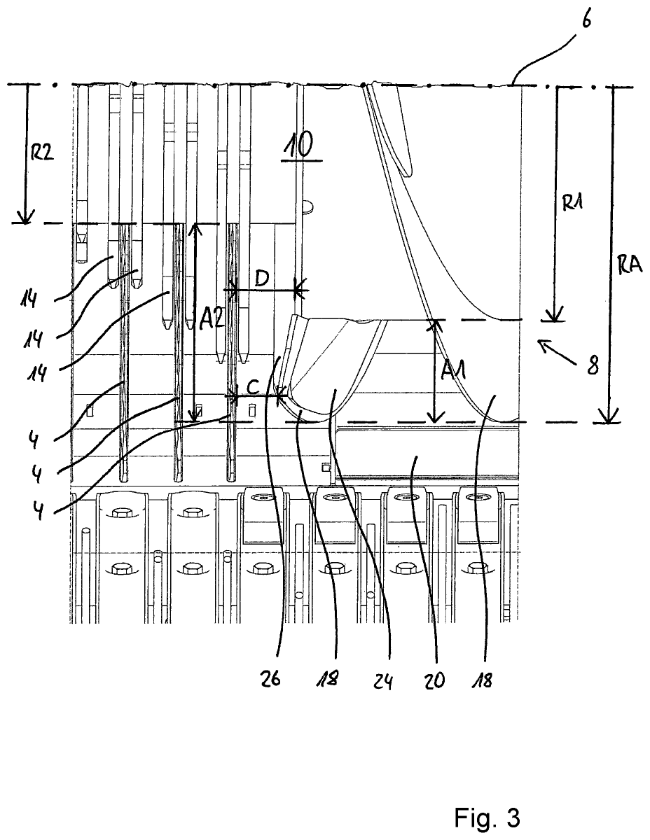

A radius R1 of the central body 10 in the axial conveying section 16 is greater than a radius R2 of the central body 10 in the central conveying section 12 (compare also FIG. 3). The ratio between the radius R1 and the radius R2 in the illustrated embodiment is 1.68. The ratio between a radius RA of the outer diameter of the axial conveying element 18 and the radius R1 of the central body 10 in the axial conveying section 16 is 1.43. The difference A2 is that between the outer radius RA of the rotor element 8 and the radius R2 of the central body 10 of the central conveying section 12 and amounts to 155 mm. The difference A1 is that between the outer radius RA of the rotor element 8 and the radius R1 of the central body 10 in the axial conveying section 16 and amounts to 80 mm. The ratio between the difference A2 and the difference A1 is 1.94 in the illustrated embodiment.

The outer radius RA amounts to 265 mm in this context. The radius R1 of the central body 10 in the axial conveying section 16 amounts to 185 mm. The radius R2 of the central body 10 in the central conveying section 12 amounts to 110 mm.

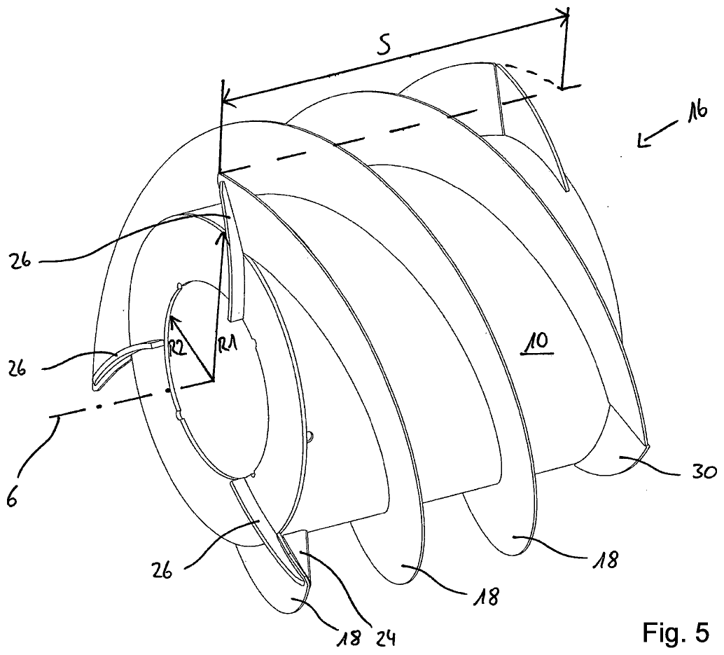

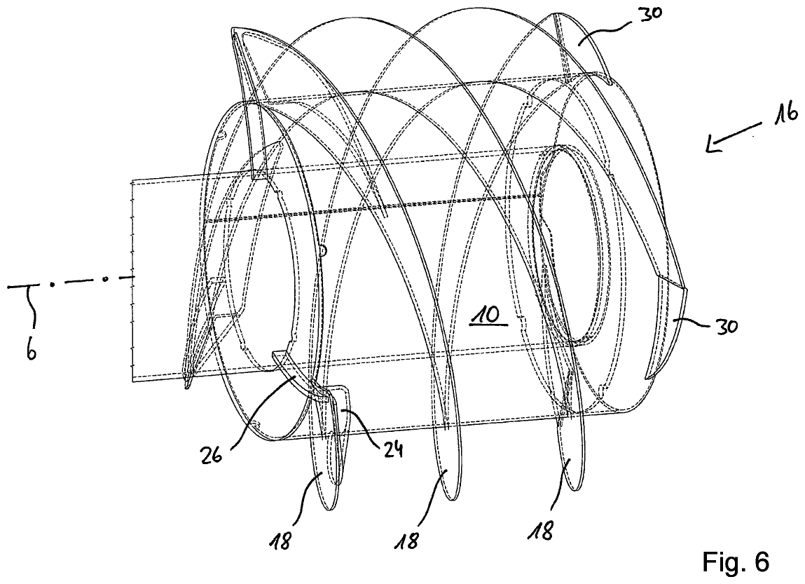

The axial conveying elements 18 of an axial conveying section 16 have a thread spacing of 145 mm. The pitch S of one of the three axial conveying elements 18 is correspondingly substantially three times this value and thus 435 mm. The pitch angle, respectively converted, amounts to approximately 14° and is constant about the entire axial conveying section 16. In this context, the axial conveying elements 18 are arranged equidistantly relative to each other (compare FIGS. 5 and 6).

A spacing C which is measured in axial direction between the axial conveying elements 18 and the nearest cutting element 3 amounts to 32 mm. A spacing D measured in axial direction between the central body 10 in the axial conveying section 16 and the nearest cutting element 4 amounts to 48 mm (compare FIG. 3).

The ends of the axial conveying elements 18 adjoining the central conveying section 12 have at a side that is facing away from the central conveying section 12 a reinforcement element 24 arranged thereat, respectively (compare FIGS. 3 and 5). At the oppositely positioned end of the axial conveying elements 18, a boundary element 30 is arranged, respectively (compare FIG. 5). In the central conveying section 12, at the central body 10 a follower element 26 for each axial conveying element 18 is arranged and adjoins the axial conveying section 16. The follow element 26 is arranged in the region of an end of the axial conveying element 18 that is facing the central conveying section 12 and has an outer radius which corresponds to the outer radius of the axial conveying element RA.

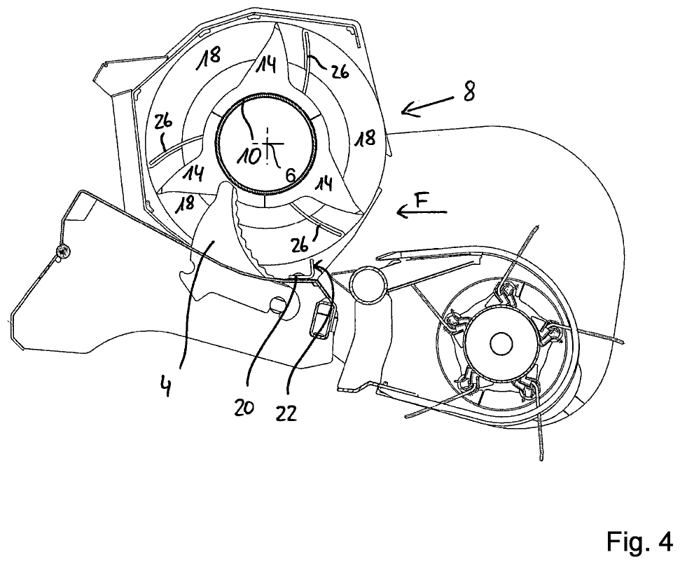

The cutting device 2 has for each axial conveying section 16 a guiding element 20 which is stationarily arranged relative to the rotor axis 6. The guiding element 20 is arranged upstream of the rotor axis 6 in relation to the overall conveying direction F of the rotor element 8 (compare FIG. 4). The guiding element 20 has a guiding surface 22 which extends transversely to the overall conveying direction F. The width B of the guiding element 20 corresponds substantially to the extension of the axial conveying section 16 in axial direction.

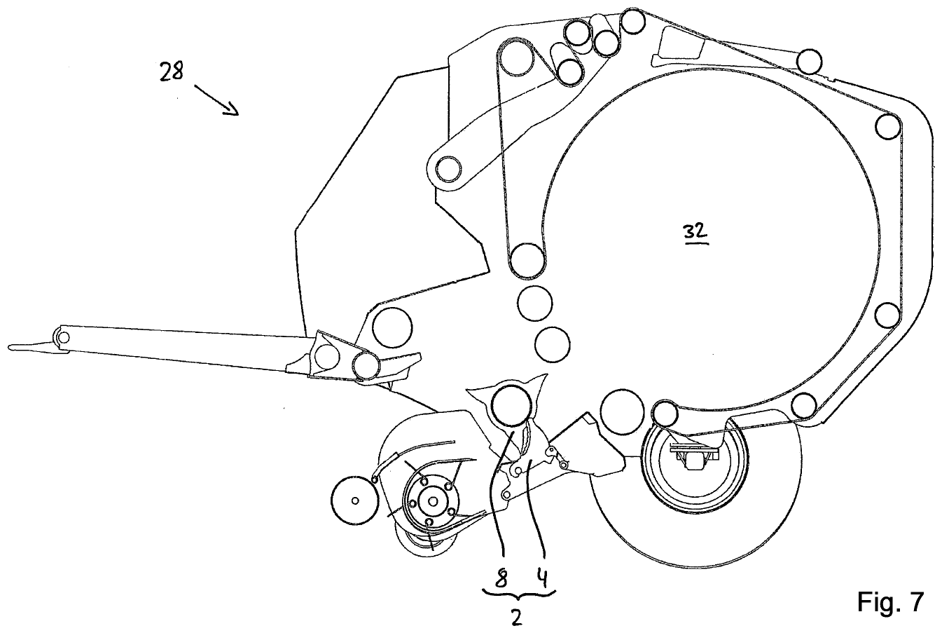

The baler 28 illustrated in FIG. 7 comprises a cutting device 2 by means of which crop to be received in the baling chamber 32 is cut in operation.

The specification incorporates by reference the entire disclosure of German priority document 10 2019 003 035.4 having a filing date of Apr. 29, 2019.

While specific embodiments of the invention have been shown and described in detail to illustrate the inventive principles, it will be understood that the invention may be embodied otherwise without departing from such principles.

What is claimed is:

1. A cutting device for agricultural crop, comprising:
cutting elements;
a rotor element configured to rotate in operation about a rotor axis, wherein the cutting elements are arranged in a cutting position stationarily relative to the rotor element and are configured to yield in a springy fashion;
wherein the rotor element comprises a central body, wherein the central body comprises a central conveying section and at least one axial conveying section;
wherein the central conveying section comprises central conveying elements correlated with the cutting elements;
wherein the at least one axial conveying section comprises an axial conveying element extending spirally at least in sections about the rotor axis;
wherein the at least one axial conveying section of the central body has a first radius and wherein the central conveying section of the central body has a second radius, wherein the first radius is larger than the second radius.

2. The cutting device according to claim 1, wherein a ratio of the first radius to the second radius amounts to at least 1.1.

3. The cutting device according to claim 1, wherein a ratio of the first radius to the second radius amounts to at most 2.5.

4. The cutting device according to claim 1, wherein a ratio of the first radius to the second radius amounts to at least 1.1 and at most 2.5.

5. The cutting device according to claim 1, wherein a ratio of an radius of an outer diameter of the axial conveying element to the first radius amounts to at most 2.0.

6. The cutting device according to claim 1, wherein a ratio of an radius of an outer diameter of the axial conveying element to the first radius amounts to at least 1.2.

7. The cutting device according to claim 1, wherein a ratio of an radius of an outer diameter of the axial conveying element to the first radius amounts to at most 2.0 and at least 1.2.

8. The cutting device according to claim 1, wherein a ratio of a first difference between an outer radius of the rotor element and the second radius to a second difference between the outer radius of the rotor element and the first radius amounts to at least 1.2.

9. The cutting device according to claim 1, wherein a ratio of a first difference between an outer radius of the rotor element and the second radius to a second difference between the outer radius of the rotor element and the first radius amounts to at most 4.0.

10. The cutting device according to claim 1, wherein a ratio of a first difference between an outer radius of the rotor element and the second radius to a second difference between the outer radius of the rotor element and the first radius amounts to at least 1.2 and at most 4.0.

11. The cutting device according to claim 1, wherein the first radius amounts to at least 120 mm and at most 250 mm.

12. The cutting device according to claim 1, wherein a difference between an outer radius of the rotor element and the first radius amounts to at least 40 mm and at most 120 mm.

13. The cutting device according to claim 1, wherein a plurality of said axial conveying element are arranged at the at least one axial conveying section and are interposed among each other.

14. The cutting device according to claim 13, wherein the plurality of said axial conveying element each have a pitch that results from a product of a number of axial conveying elements contained in the plurality multiplied by an individual pitch of the axial conveying elements.

15. The cutting device according to claim 1, wherein the axial conveying element has an individual pitch of at least 100 mm and at most 200 mm

16. The cutting device according to claim 1, wherein a spacing measured in axial direction between the axial conveying element and a nearest one of the cutting elements amounts to at most 55 mm.

17. The cutting device according to claim 1, wherein an end of the axial conveying element adjoining the central conveying section has a side facing away from the central conveying section, wherein the side facing away from the central conveying section is provided with a reinforcement element.

18. The cutting device according to claim 1, further comprising at least one follower element arranged in the central conveying section at the central body so as to adjoin the at least one axial conveying section.

19. The cutting device according to claim 1, wherein the at least one follower element is arranged in a region of an end of the axial conveying element facing the central conveying section and comprises an outer radius corresponding substantially to an outer radius of the axial conveying element.

20. The cutting device according to claim 1, further comprising at least one guiding element arranged stationarily relative to the rotor axis and, viewed in an overall conveying direction of the cutting device, arranged upstream of the rotor axis, wherein the at least one guiding element is provided with a guiding surface that extends substantially transverse to the overall conveying direction of the cutting device.

21. An agricultural machine comprising a cutting device according to claim 1.

22. The agricultural machine according to claim 21 embodied as a baler.

23. The agricultural machine according to claim 21 embodied as a a self-loading trailer.
